(19) United States
(12) Patent Application Publication
(10) Pub. No.: US 2025/0382985 A1
(43) Pub. Date: Dec. 18, 2025

(54) Trace Routing Fastener

(71) Applicant: Illinois Tool Works Inc., Glenview, IL (US)

(72) Inventor: Joel R. Lee, PEOTONE, IL (US)

(21) Appl. No.: 19/233,139

(22) Filed: Jun. 10, 2025

Related U.S. Application Data
(60) Provisional application No. 63/660,817, filed on Jun. 17, 2024.

(51) Int. Cl. F16B 19/00; F16L 3/12

(52) U.S. Cl. CPC F16B 19/002; F16L 3/12

(57) ABSTRACT

A fastener assembly is described for coupling a second component, via a strap, to an opening in a first component. The assembly includes a lock pin and a base structure. The lock pin has a shank with a head at one end and a lock tab at the opposite end. The base structure includes a grommet portion defining a grommet opening and a pair of resilient legs configured to engage the opening. The head comprises a fixed planar portion attached to the shank and at least one hinged wing portion. An installation indicator spans at least part of both the fixed and wing portions. The grommet opening receives at least part of the shank and includes a protrusion feature that secures the lock pin in a first assembled position. At least one leg includes a resilient flex tab configured to retain the base structure within the opening of the first component.

### RELATED APPLICATION

The present application claims priority to U.S. Provisional Patent Application No. 63/660,817, filed Jun. 17, 2024, and entitled “Trace Routing Fastener,” which is hereby incorporated by reference in its entirety.

### BACKGROUND

Automotive components require fastening techniques that are simple to manufacture and assemble. Further, fastening techniques should above all be reliable and efficient. In some instances, objects need to be secured to the vehicle to mitigate movement and/or shifting during operation, which can result in damage or kinking to the object. For example, tube, hoses, wires, and other objects are often secured to the vehicle components via fasteners. When a fastener is installed incorrectly such that the fastener is not fully inserted into the opening, the fastener can detach and/or the object being fastened can become damaged or loose. Similarly, when an object is attached incorrectly to a fastener, the object can detach from the fastener or become damaged or loose.

Conventional fastening or assembly systems often require the use of bolts and heavy tools during installation on assembly lines. This not only increases the overall weight of the system but also introduces complexity, higher labor demands, and potential delays in the manufacturing process.

Therefore, it would be desirable to provide an installation indicator to enhance proper installation of the object relative to the fastener and/or the fastener relative to the first component during assembly.

### SUMMARY

The present disclosure relates generally to a fastening system to form a connection between the first and second components, such as tubes and panels. More specifically, a fastener with an installation indicator to enhance proper installation of the object relative to the fastener and/or the fastener relative to the first component during assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate a fastening system configured to secure one or more second components relative to a first component via a fastener assembly having a lock pin and a base structure, in accordance with aspects of this disclosure.

FIGS. 2a through 2c illustrate perspective views of the fastener assembly in, respectively, a disassembled position, a first assembled position, and a second assembled position.

FIGS. 2d through 2f illustrate side elevation views of the fastening system in, respectively, a disassembled position (rear view), a first assembled position (rear view), and a second assembled position (front view).

FIGS. 2g and 2h illustrate side elevation cross-sectional views of the fastening system taken along cutline A-A (FIG. 2b) during assembly.

FIG. 2i illustrates a top plan view of the fastener assembly.

FIG. 3a illustrates a perspective view of the fastener assembly in the first assembled position.

FIGS. 3b and 3c illustrate perspective views of the fastener assembly in the first assembled position, taken along cutline B-B (FIG. 3a) and cutline C-C(FIG. 3a), respectively.

FIG. 3d illustrates a perspective view of the fastener assembly in the second assembled position.

FIGS. 3e and 3f illustrate perspective views of the fastener assembly in the second assembled position, taken along cutline D-D (FIG. 3d) and cutline E-E (FIG. 3d), respectively.

FIGS. 4a and 4b illustrate, respectively, topside perspective and underside perspective views of the lock pin.

FIGS. 4c through 4f illustrate, respectively, first, second, third, and fourth side elevation views of the lock pin.

FIGS. 4g and 4h illustrate, respectively, top, and bottom plan views of the lock pin.

FIGS. 5a and 5b illustrate, respectively, topside perspective and underside perspective views of the base structure.

FIGS. 5c through 5f illustrate, respectively, first, second, third, and fourth side elevation views of the base structure.

FIGS. 5g and 5h illustrate, respectively, top, and bottom plan views of the base structure.

FIGS. 6a and 6b illustrate, respectively, assembly and assembled isometric views of the fastener assembly with the first component and a visual quality system.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC). The processor may be coupled to or integrated with a memory device. The memory device can be any suitable type of computer memory or any other type of electronic storage medium, such as, for example, read-only memory (ROM), random access memory (RAM), cache memory, compact disc read-only memory (CD-ROM), electro-optical memory, magneto-optical memory, programmable read-only memory (PROM), erasable programmable read-only memory (EPROM), electrically erasable programmable read-only memory (EEPROM), a computer-readable medium, or the like.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosed fastener assembly in accordance with an aspect of the disclosure addresses deficiencies in the art through an all-plastic construction that eliminates the need for tools during assembly, thereby simplifying the installation process and reducing weight. The design further enables visual or automated assembly verification through integrated features compatible with vision systems. Specifically, the design incorporates scannable elements that allow for real-time confirmation of proper assembly without physical inspection or manual validation.

In a first example, a fastener assembly for coupling a second component via a strap to an opening formed in a first component comprises: a lock pin having a shank with a head positioned at a first end and a lock tab positioned at a second end opposite the first end, wherein the head comprises a fixed planar portion coupled to the shank and at least one wing portion coupled to the fixed planar portion via a hinge, and wherein the head further comprises an installation indicator positioned over at least a portion of both the fixed planar portion and the at least one wing portion; and a base structure having a grommet portion that defines a grommet opening and a pair of legs resiliently coupled to the grommet portion and configured to engage with the opening, wherein the grommet opening is configured to receive at least a portion of the shank and includes a protrusion feature configured to secure the lock pin relative to the base structure in a first assembled position, and wherein a leg of the pair of legs includes a flex tab feature resiliently coupled thereto and configured to retain the base structure relative to the first component via the opening.

In a second example, a fastener assembly for coupling a second component via a strap to an opening formed in a first component comprises: a lock pin having a shank and a head; and a base structure having a grommet portion that defines a grommet opening and a pair of legs resiliently coupled to the grommet portion and configured to engage with the opening, wherein the grommet opening is configured to receive at least a portion of the shank, wherein the pair of legs are spaced apart to define a central recess therebetween, and wherein a leg of the pair of legs includes a flex tab feature resiliently coupled thereto and configured to retract into the central recess during assembly and to retain the base structure relative to the first component via the opening.

In a third example, a fastener assembly for coupling a second component via a strap to an opening formed in a first component comprises: a lock pin having a shank with a head positioned at a first end and a lock tab positioned at a second end opposite the first end, wherein the head comprises a fixed planar portion coupled to the shank and at least one wing portion coupled to the fixed planar portion via a hinge, and wherein the head further comprises an installation indicator positioned over at least a portion of both the fixed planar portion and the at least one wing portion; and a base structure having a grommet portion that defines a grommet opening and a pair of legs resiliently coupled to the grommet portion and configured to engage with the opening, wherein the grommet opening is configured to receive at least a portion of the shank and includes a protrusion feature configured to secure the lock pin relative to the base structure in a first assembled position.

In some examples, the strap is a zip tie or a cable strap.

In some examples, the lock pin comprises a lock tab positioned on the shank at an end opposite the head.

In some examples, the head comprises a fixed planar portion coupled to the shank and at least one wing portion coupled to the fixed planar portion via a hinge.

In some examples, the head further comprises an installation indicator positioned over at least a portion of both the fixed planar portion and the at least one wing portion.

In some examples, the flex tab feature comprises a sloped body portion and a movable base portion that resiliently couples the flex tab feature to the leg.

In some examples, the movable base portion is coupled to the leg at a surface thereof located within the central recess.

In some examples, the sloped body portion is a wedge-shaped fin.

In some examples, the installation indicator is a fiducial marker. For example, a quick response (QR) code, a bar code, etc.

In some examples, the wing portion is movable between a first assembled position that corresponds to a pre-installation position and a second assembled position that corresponds to an installed position.

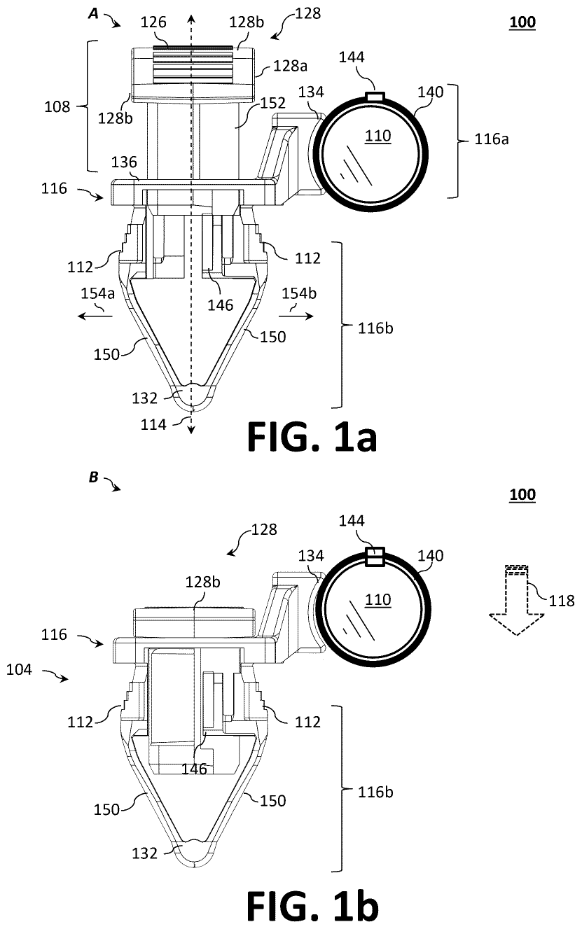

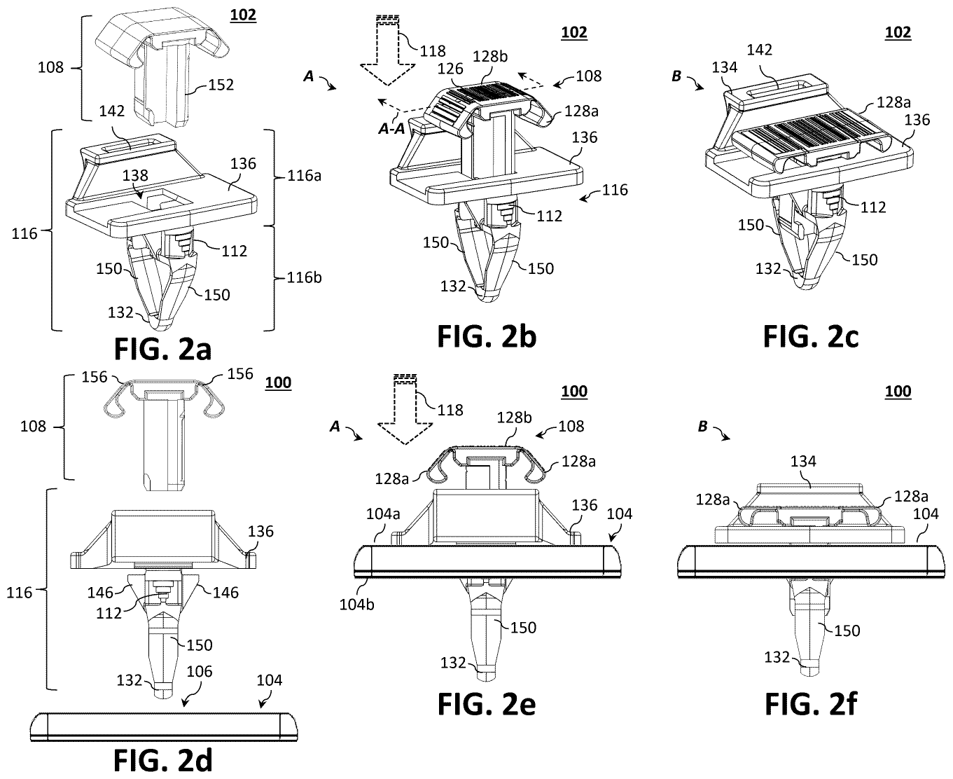

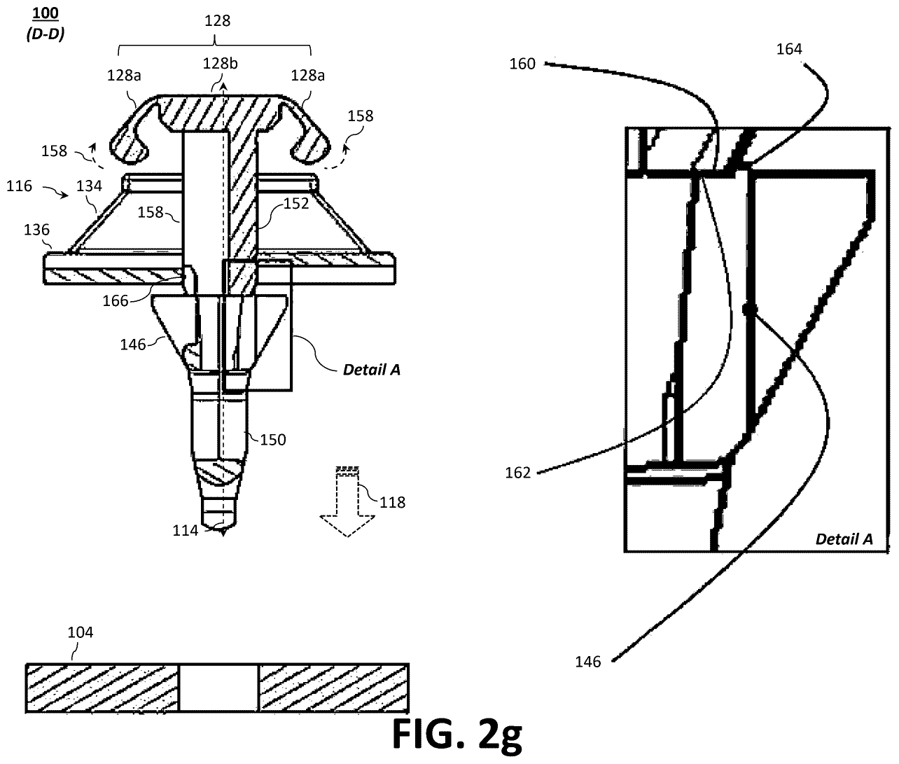

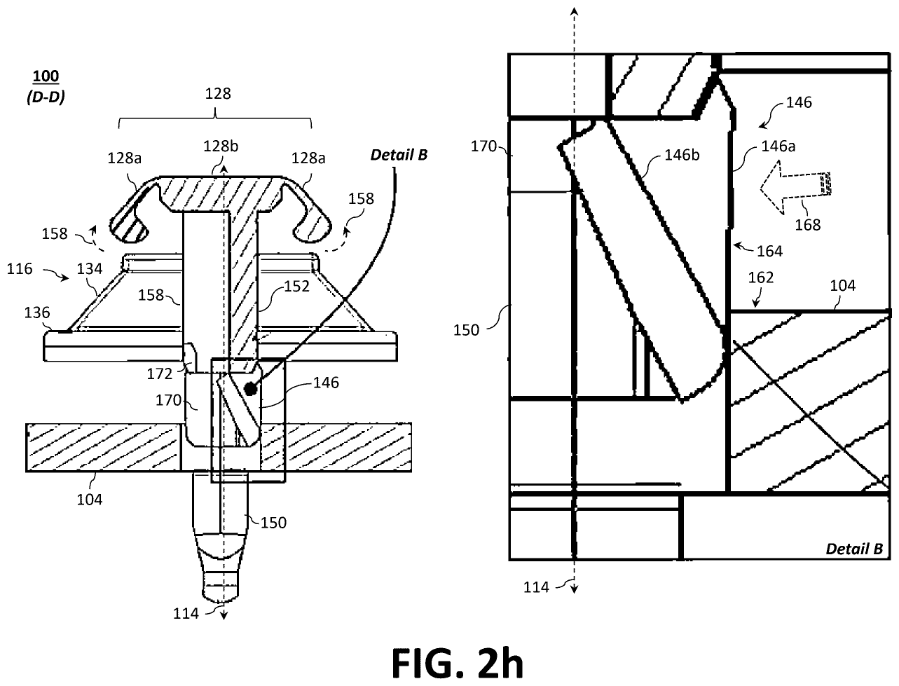

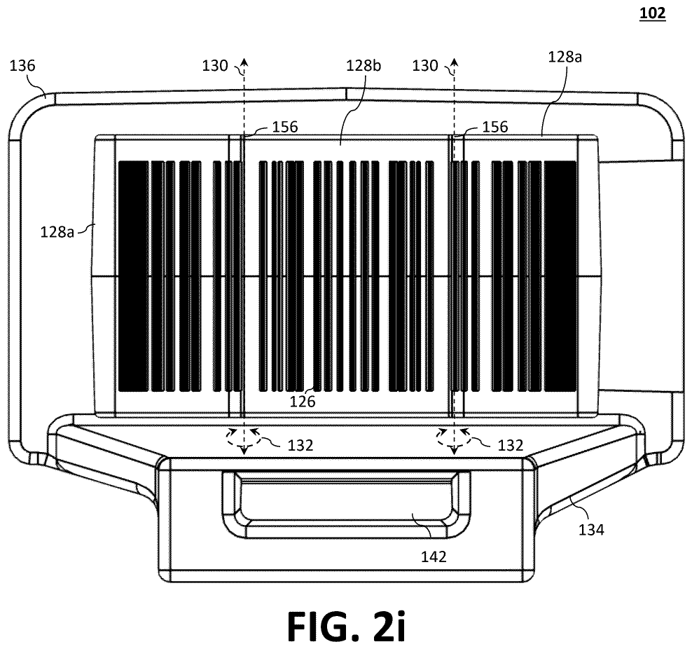

FIGS. 1a and 1b illustrate a fastening system 100 configured to secure one or more second components 110 relative to a first component 104 via a fastener assembly 102 having a lock pin 108 and a base structure 116, in accordance with aspects of this disclosure. The fastening system 100 generally includes a fastener assembly 102 configured for installation into a first component 104. For illustrative purposes, the first component 104 is omitted from FIGS. 1a and 1b, but an example is illustrated in FIGS. 2d through 2g. The second components 110 may include brake lines, fuel lines, electrical cables, pipes, or other tubular or elongate structures.

The first component 104 defines an opening 106 configured to receive and retain the fastener assembly 102. The first component 104 includes an A-side surface 104a (e.g., exterior surface) and a B-side surface 104b (e.g., interior surface). The one or more second components 110 are mounted to the A-side surface 104a via the fastener assembly 102. The first component 104 may comprise structural or body elements of a vehicle-such as doors, pillars (A-, B-, or C-pillars), dashboard components, seat frames, center consoles, fenders, sheet metal framework, or similar elements.

Depending on the application, the first component 104 may be formed from metal, metal alloys, synthetic or semi-synthetic polymers (e.g., ABS or PVC), composite materials (e.g., fiberglass), or combinations thereof. The opening 106 may be integrally formed during manufacturing and is generally rectangular in the illustrated example, though other geometries-such as circular, oval, triangular, or other quadrilateral openings—are also contemplated.

Details of the fastener assembly 102 are illustrated in greater at FIGS. 2a through 2i. Specifically, FIGS. 2a through 2c illustrate perspective views of the fastener assembly 102 in, respectively, a disassembled position, a first assembled position (position A), and a second assembled position (position B) and FIGS. 2d through 2f illustrate side elevation views of the fastening system 100 in, respectively, a disassembled position (rear view), a first assembled position (position A) (rear view), and a second assembled position (position B) (front view). Finally, FIGS. 2g and 2h illustrate a side elevation cross-sectional view of the fastening system 100 taken along cutline A-A (FIG. 2b) in the first assembled position (position A), while FIG. 2i illustrates a top plan view of the fastener assembly 102.

The fastener assembly 102 comprises multiple components, including a lock pin 108 and a base structure 116. In some examples, the fastener assembly 102 can be preassembled in the first assembled position to serve as a shipped, pre-install configuration.

The fastener assembly 102 also includes one or more features on the base structure 116 that facilitate securing the second component 110 via a strap 140. For example, the base structure 116 includes a carrier portion 116a and a fastener portion 116b. The carrier portion 116a and the fastener portion 116b can be formed as a single, unitary component. Alternatively, the fastener portion 116b may be attached to the carrier portion 116a using adhesives, welding, mechanical fasteners, or other joining methods. Additional features-such as ribs or wings—may be incorporated to mitigate vibration, noise, or rattle (BSR) between the fastener assembly 102 and the first component 104.

The carrier portion 116a is configured to engage one or more second components 110 and secure them relative to the first component 104. In the illustrated embodiment, the carrier portion 116a includes a payload portion 134 and a grommet portion 136. The payload portion 134 interfaces with the second component 110, while the grommet portion 136 defines a grommet opening 138 configured to receive the lock pin 108.

The fastener portion 116b is configured to connect the carrier portion 116a to the first component 104. In the illustrated example, the fastener portion 116b is configured to snap into the opening 106 of the first component 104 during installation.

In the illustrated example, a strap opening 142 is defined through the payload portion 134. A strap 140 is threaded through the strap opening 142 and looped around the second component 110, with the free ends fastened using a strap fastener 144. Suitable strap fasteners 144 may include ratcheting mechanisms, latches, snaps, clips, hook-and-loop fasteners, or cable ties (e.g., zip ties).

While a single strap 140 and a single strap opening 142 are illustrated, additional or fewer straps 140 and strap openings 142 may be used depending on design requirements and the number of second components 110 to be secured. The dimensions of the carrier portion 116a can be modified to accommodate the necessary number of straps or components. Although described in the context of securing tubes, the fastener assembly 102 may be used to attach various other objects.

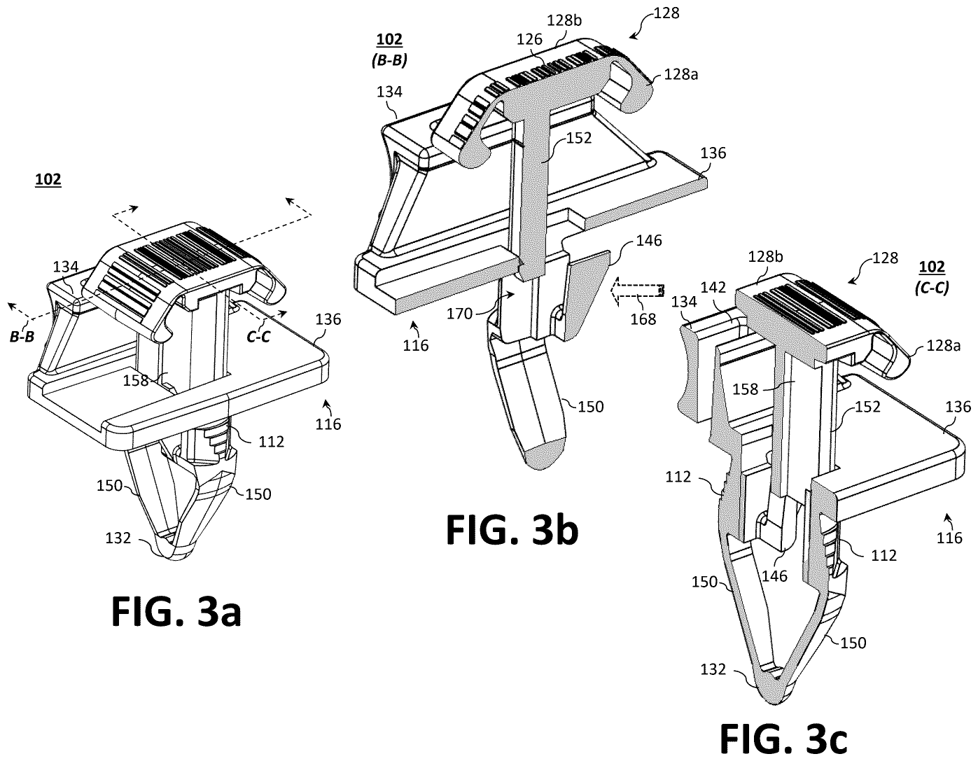

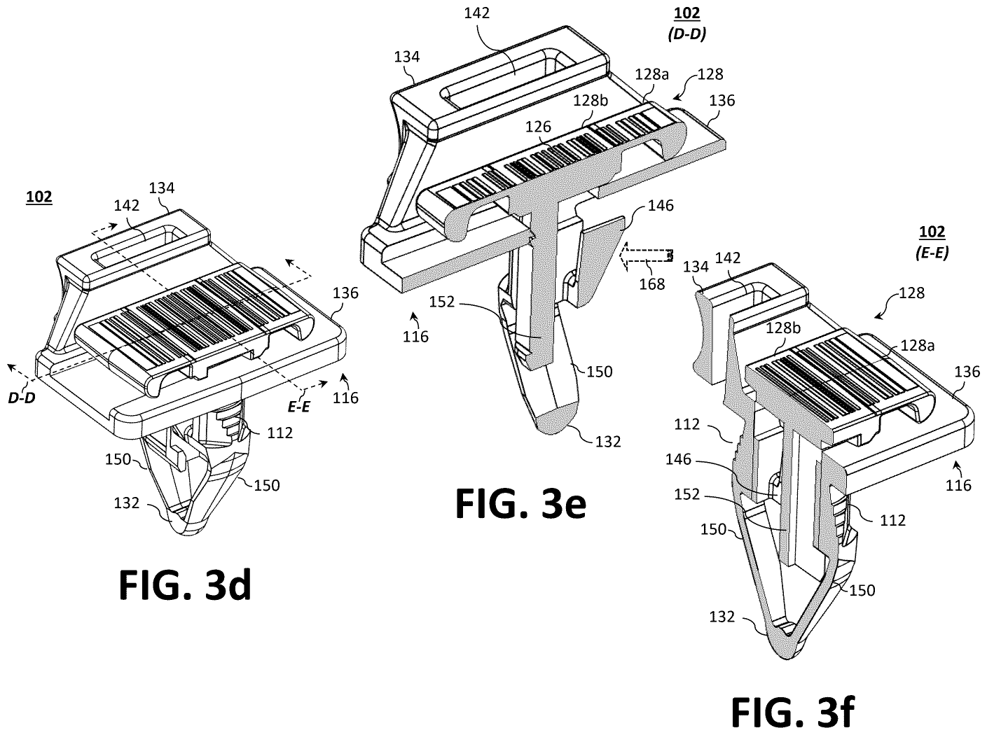

FIGS. 3a through 3f illustrate the fastener assembly 102 during various stages of assembly. FIG. 3a illustrates a perspective view of the fastener assembly 102 in the first assembled position (position A), while FIGS. 3b and 3c illustrate perspective views of the fastener assembly 102 in the first assembled position (position A), taken along cutline B-B (FIG. 3a) and cutline C-C(FIG. 3a), respectively. FIG. 3d illustrates a perspective view of the fastener assembly 102 in the second assembled position (position B), while FIGS. 3e and 3f illustrate perspective views of the fastener assembly 102 in the second assembled position (position B), taken along cutline D-D (FIG. 3d) and cutline E-E (FIG. 3d), respectively.

During installation, a leading end 132 of the fastener portion 116b is inserted into the opening 106 of the first component 104 in the direction shown by arrow 118. The fastener portion 116b extends generally perpendicularly to the carrier portion 116a and includes a central longitudinal axis 114. In the illustrated embodiment, the fastener portion 116b comprises a pair of resilient legs 150 attached to the underside of the carrier portion 116a. The distal ends of the resilient legs 150 converge and are connected at the leading end 132. The fastener portion 116b further comprises a plurality of steps 112 (or ribs) formed on the exterior surfaces of the resilient legs 150. These steps 112 are positioned near the base of the resilient legs 150, adjacent to the carrier portion 116a, and are oriented to face outward, away from the central longitudinal axis 114.

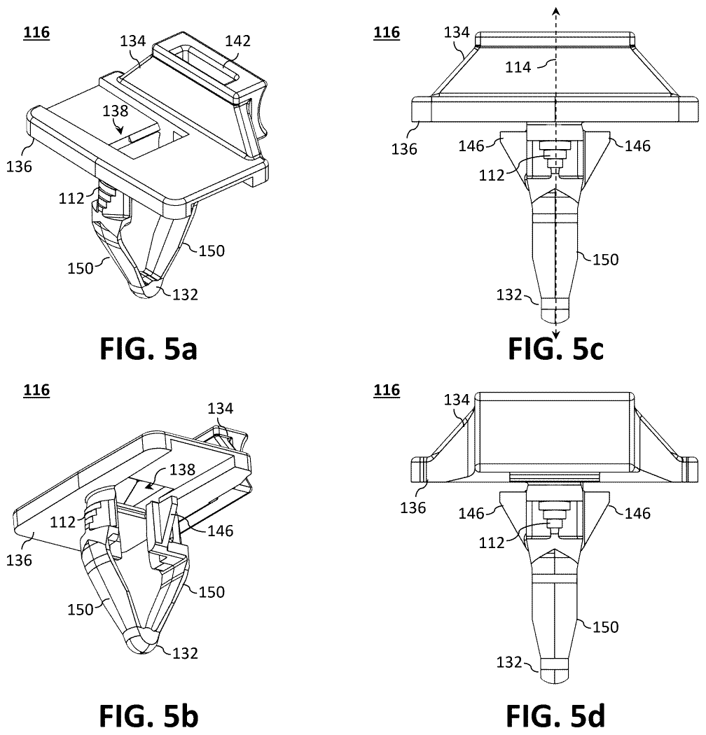

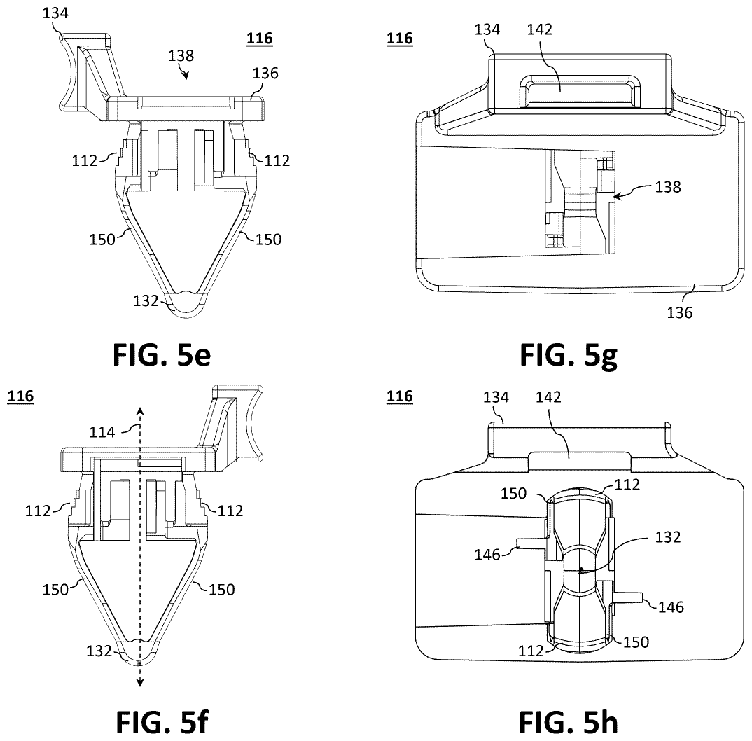

Each step 112 extends circumferentially or partially circumferentially around the leg surface and includes a ledged or shoulder-like feature configured to catch or engage the internal surface of the opening 106 formed in the first component 104. With reference to FIGS. 5e and 5f, for example, the steps 112 become smaller as they progress toward the carrier portion 116a.

The steps 112 may be tapered or include angled surfaces to facilitate guided insertion and gradual resistance as the fastener portion 116b is inserted. The plurality of steps 112 enables the fastener assembly to securely accommodate a range of thicknesses and tolerances at the opening 106, providing incremental engagement points. This multi-step engagement helps ensure a firm fit, compensates for dimensional variation, and mitigates buzz, squeak, and rattle (BSR) noise during use or vibration.

Each leg 150 includes an inner protrusion 148a oriented inward toward the central axis 114, and an outer protrusion 148b oriented outward. These protrusions interface with the shank 152 of the lock pin 108 and the first component 104 to ensure secure engagement.

The legs 150 are configured to deflect inward toward the central axis 114 during insertion into the opening 106. Once fully inserted, the shank 152 of the lock pin 108 biases the legs 150 outward (as indicated in FIG. 1a by arrows 154a and 154b) to secure the fastener portion 116b within the opening 106.

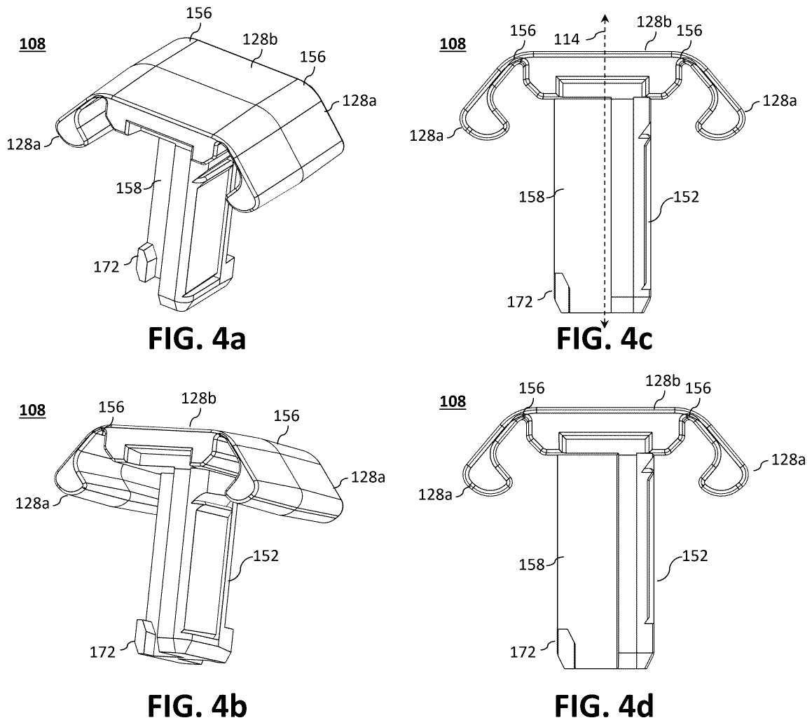

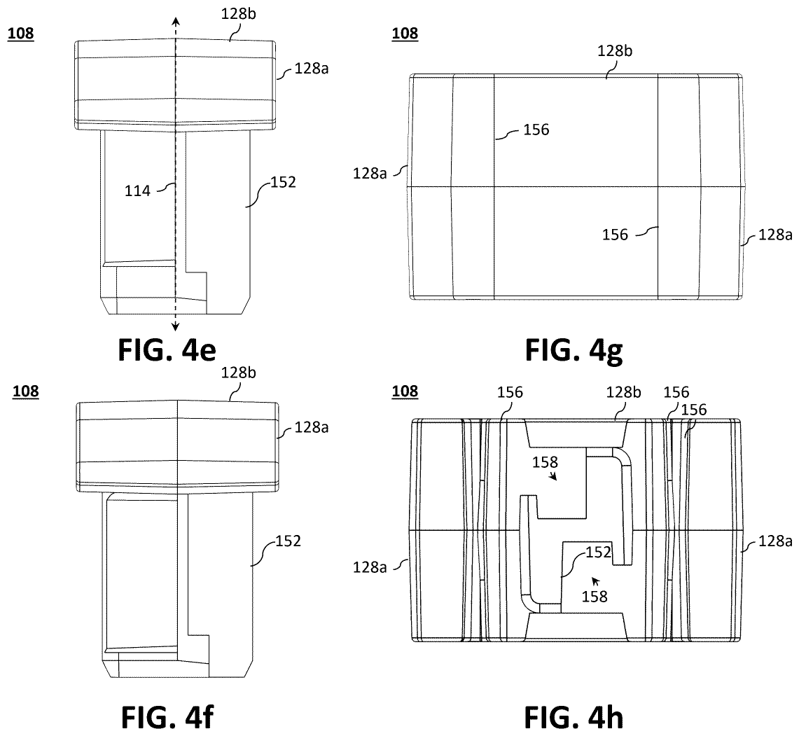

Detailed views of the lock pin 108 and base structure 116 are illustrated by, respectively, FIGS. 4a through 4h and FIGS. 5a through 5h. Specifically, FIGS. 4a and 4b illustrate, respectively, topside perspective and underside perspective views of the lock pin 108, while FIGS. 4c through 4f illustrate, respectively, first, second, third, and fourth side elevation views of the lock pin 108 and FIGS. 4g and 4h illustrate, respectively, top and bottom plan views of the lock pin 108. Similarly, FIGS. 5a and 5b illustrate, respectively, topside perspective and underside perspective views of the base structure 116, while FIGS. 5c through 5f illustrate, respectively, first, second, third, and fourth side elevation views of the base structure 116 and FIGS. 5g and 5h illustrate, respectively, top and bottom plan views of the base structure 116.

The lock pin 108 and base structure 116 may each be formed as unitary components using plastic injection molding or additive manufacturing. In additive examples, components may be fabricated via fused deposition modeling (FDM), stereolithography (SLA), selective laser sintering (SLS), or other 3D printing methods, offering precision and flexibility, particularly for complex geometries and low-volume production.

Additive manufacturing processes consider horizontal resolution (X-Y plane) and vertical resolution (Z-axis layer thickness). Horizontal resolution typically ranges from 50-100 μm (510-250 DPI), while vertical resolution can range from 16-100 μm (1,600-250 DPI). Higher resolutions yield finer detail but increase production time. Different portions of the fastener assembly 102 may be printed at different resolutions based on functional or design needs.

Improper installation of the second component 110 or the fastener assembly 102 may lead to detachment or misalignment. Improper attachment may also damage or loosen the first components. To support installation tracking, the lock pin 108 includes a head 128 affixed to shank 152. The head 128 comprises a fixed planar portion 128b and one or more wing portions 128a that can pivot relative to the fixed portion about a pivot axis 130. The wing portions 128a are connected to the fixed planar portion 128b via film hinges 156, which permit pivoting movement.

In the illustrated example, the head 128 includes two wing portions 128a on opposite sides of the fixed planar portion 128b. The installation indicator 126 spans all three sections. When the head 128 is fully seated (position B), the three portions align in a common plane, allowing the visual system 120 to read the indicator. In intermediate or pre-install positions (position A), the wing portions are angled downward, making the indicator unreadable. Contact with the grommet portion 136 causes the wing portions 128a to pivot upward as the lock pin 108 is pushed into place.

An installation indicator 126—such as a barcode or QR code—is affixed to or integrated with the head 128 and can be detected by a visual quality system 120. If the lock pin 108 is improperly installed, the wing portions 128a may not align with the fixed portion to assume the second assembled position, resulting in a misaligned position. This misalignment prevents the visual quality system 120 from reading the installation indicator 126, signaling improper assembly.

The fastener assembly 102 is configured to be mounted to a first component 104, such as vehicle frame, after it has been pre-attached to second component 110 (e.g., a wire harness) using a strap 140, such as a zip tie or cable strap. During installation, the fastener assembly 102 can first be attached to a first component bundle using strap 140.

As shown in FIGS. 2b and 2d, during shipping and prior to installation, the lock pin 108 is maintained in a part-in-assembly (PIA) position relative to the base structure 116. This is achieved through engagement between a lock tab 172, located on the lock pin 108, and a corresponding feature on the base structure 116. In the illustrated embodiment, lock tab 172 is formed as a fixed lateral protrusion extending from the shank 152 of the lock pin 108, near its distal (free) end.

The lock tab 172 is configured to produce an interference fit with the base structure 116, thereby temporarily holding the lock pin 108 in its first (PIA) position. For example, lock tab 172 may engage either an inner wall of the grommet opening 138 or a structural element-such as a notch, recess, or ledge-within a cavity or recess 170 located between a pair of resilient legs 150 of the base structure 116.

The base structure 116 further includes one or more flex tab features 146, which are formed integrally with, or attached to, the resilient legs 150. These flex tab features 146 are designed to retain the base structure 116 within a first component 104 by engaging an opening 106 when the fastener system is in its second assembled position. These tabs are located either within or adjacent to the central recess 170, near the proximal ends of the legs—i.e., close to the point where each leg connects to the carrier portion 116a.

Each flex tab feature 146 comprises a sloped body portion 146a (e.g., triangular, or wedge-shaped fin), and a movable base portion 146b, which is resiliently or pivotally coupled to its respective leg 150.

These flex tab features 146 are designed to deflect toward or away from the central longitudinal axis 114 during insertion into the opening 106. For instance, as base structure 116 is pressed into the first component 104, an outer edge of the opening 106 applies an inward biasing force (indicated by arrow 168) onto the sloped portion 146a, causing the tab 146 to temporarily retract into the recess 170.

Once the flex tab features 146 are removed from the opening 106 (pass through the opening 106 in the case of a thin first component 104), the flex tab features 146 resiliently return to their original extended positions. A portion of the sloped body 146a-such as its upper edge-then abuts against a surface of the first component 104 (e.g., an interior sidewall of the opening 106), mitigating back-out of the base structure 116.

The lock pin 108 is then advanced through the grommet opening 138 until it reaches a second assembled position. Prior to full installation, the visual quality system 120 cannot read the barcode or QR code positioned on the planar portion 128b and wing portions 128a of the lock pin 108. Once fully seated, the resilient legs 150 splay outward (see arrows 154a and 154b, FIG. 1h), anchoring the base structure 116 inside the first component 104. Simultaneously, the wing portions 128a flatten, enabling the visual system 120 to verify installation.

To secure the assembly during shipping, additional interlocking features are included. Specifically, the lock pin 108 includes an engagement ledge 160 and a positioning protrusion 164. The engagement ledge 160 contacts a positioning edge 162 on the flex tab features 146. This prevents forward movement when axial force is applied in the direction of arrow 118. The positioning protrusion 164, which keeps the resilient legs 150 in a controlled pre-installation orientation relative to the lock pin 108. These features can be rotationally symmetrical, with two of each used in the current configuration, though one or more may be used in alternate designs.

During final installation of the fastener assembly 102 into the first component 104, continued pressure (direction of arrow 118) causes the flex tab features 146 to flex inward (as shown by arrow 168), allowing the positioning protrusion 164 to disengage from the engagement ledge 160. This enables the lock pin 108 to advance into its fully seated position.

Additionally, the lock tabs 172 on the lock pin 108 engage with protrusion features 166 on the base structure 116. These features cooperate to prevent axial back-out of the lock pin 108 from either the shipping or final installed positions, thereby improving retention and overall system robustness.

In some aspects, the lock pin 108 includes a channel 158 formed along at least a portion of the shank 152. This channel aligns with the flex tab features 146 during insertion, allowing them to freely move toward and away from the axis 114. In configurations where flex tabs 146 are asymmetrically positioned (see FIG. 5h), the channel 158 may also be asymmetrically located to match.

In other designs, the channel 158 may be omitted. In such cases, the shank 152 obstructs the inward motion of the flex tab features 146, holding them in an outwardly deployed state. This locked-out configuration may be desirable where maximum mechanical retention, structural rigidity, or vibration resistance is required-such as in aerospace, automotive, or structural panel applications.

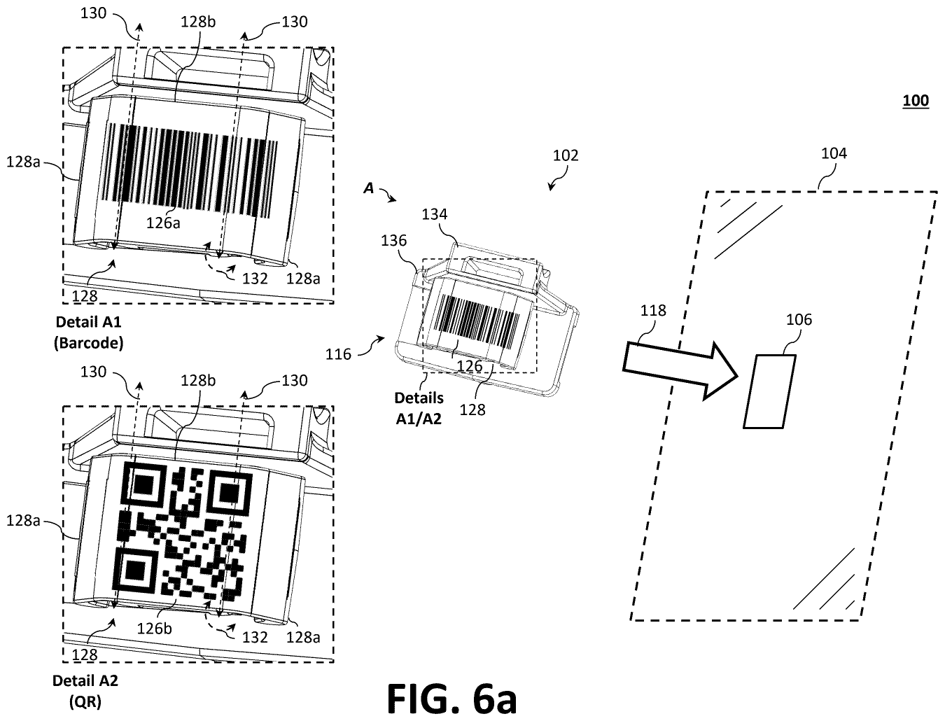

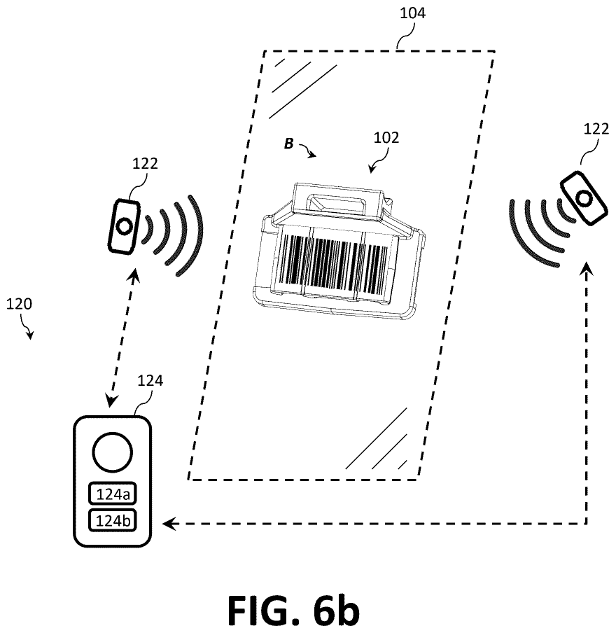

FIGS. 6a and 6b illustrate, respectively, assembly and assembled isometric views of the fastener assembly 102 with the first component 104 and a visual quality system 120. The fastening system 100 can be used in conjunction with a visual quality system 120, which includes a reader 122 and a computer 124. The reader 122, which may be connected to the computer 124 via a wired or wireless connection, is positioned adjacent to the fastener assembly 102 and/or the first component 104 to monitor the assembly process, including the insertion of a second component 110.

In some embodiments, the head 128 is designed so that one or more installation indicators 126 remain hidden from the visual quality system 120 until the lock pin 108 is fully assembled. Specifically, if the lock pin 108 is not completely seated, the wing portions 128a will not lie flush (flat) with the fixed planar portion 128b, and the system either cannot detect the installation indicator 126 or detects an incorrect angle. In either case, the visual quality system 120 registers an error or anomaly.

Based on data from the installation indicator(s) 126, the computer 124 (via processor 124a and memory 124b) can determine whether the fastener assembly 102 is properly installed into the first component 104. If improper installation is detected, the system can alert an operator (e.g., via a portable communication device). In automated or robotic applications, the robot may automatically repeat the assembly process to correct the error.

While a single installation indicator 126 is illustrated, multiple indicators may be used to enhance redundancy or accuracy by providing several positional data points. Additionally, indicators can be located elsewhere on the fastener assembly 102, such as on a sidewall of the carrier portion 116a, either as a supplement to or replacement for the head-mounted indicator.

The installation indicator 126 is affixed to the head 128, either printed directly, applied as a label, or attached by another method. The wing portions 128a are connected to the fixed planar portion 128b by hinges 156 and can pivot between a raised (first) and flat (second) position. The head 128 achieves the second assembled position only when the lock pin 108 is fully seated in the base structure 116. The reader 122, separate from the fastener assembly 102 and operatively connected to a computer, is configured via processor 124a to track the installation indicator 126 during installation of either the fastener assembly 102 or second component 110.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly for coupling a second component via a strap to an opening formed in a first component, the fastener assembly comprising:
a lock pin having a shank with a head positioned at a first end and a lock tab positioned at a second end opposite the first end,
wherein the head comprises a fixed planar portion coupled to the shank and at least one wing portion coupled to the fixed planar portion via a hinge, and
wherein the head further comprises an installation indicator positioned over at least a portion of both the fixed planar portion and the at least one wing portion; and
a base structure having a grommet portion that defines a grommet opening and a pair of legs resiliently coupled to the grommet portion and configured to engage with the opening,
wherein the grommet opening is configured to receive at least a portion of the shank and includes a protrusion feature configured to secure the lock pin relative to the base structure in a first assembled position, and
wherein a leg of the pair of legs includes a flex tab feature resiliently coupled thereto and configured to retain the base structure relative to the first component via the opening.

2. The fastener assembly of claim 1, wherein the pair of legs are spaced apart to define a central recess therebetween and the flex tab feature is configured to retract into the central recess during assembly.

3. A fastener assembly for coupling a second component via a strap to an opening formed in a first component, the fastener assembly comprising:
a lock pin having a shank and a head; and
a base structure having a grommet portion that defines a grommet opening and a pair of legs resiliently coupled to the grommet portion and configured to engage with the opening,
wherein the grommet opening is configured to receive at least a portion of the shank,
wherein the pair of legs are spaced apart to define a central recess therebetween, and
wherein a leg of the pair of legs includes a flex tab feature resiliently coupled thereto and configured to retract into the central recess during assembly and to retain the base structure relative to the first component via the opening.

4. The fastener assembly of claim 3, wherein the lock pin comprises a lock tab positioned on the shank at an end opposite the head.

5. The fastener assembly of claim 3, wherein the head comprises a fixed planar portion coupled to the shank and at least one wing portion coupled to the fixed planar portion via a hinge.

6. The fastener assembly of claim 5, wherein the head further comprises an installation indicator positioned over at least a portion of both the fixed planar portion and the at least one wing portion.

7. The fastener assembly of claim 3, wherein the flex tab feature comprises a sloped body portion and a movable base portion that resiliently couples the flex tab feature to the leg.

8. The fastener assembly of claim 7, wherein the movable base portion is coupled to the leg at a surface thereof located within the central recess.

9. The fastener assembly of claim 7, wherein the sloped body portion is a wedge-shaped fin.

10. The fastener assembly of claim 6, wherein the installation indicator is a fiducial marker.

11. The fastener assembly of claim 6, wherein the wing portion is movable between a first assembled position that corresponds to a pre-installation position and a second assembled position that corresponds to an installed position.

12. The fastener assembly of claim 10, wherein the installation indicator is a quick response (QR) code.

13. The fastener assembly of claim 10, wherein the installation indicator is a bar code.

14. The fastener assembly of claim 3, wherein the strap is a zip tie or a cable strap.

15. A fastener assembly for coupling a second component via a strap to an opening formed in a first component, the fastener assembly comprising:
a lock pin having a shank with a head positioned at a first end and a lock tab positioned at a second end opposite the first end,
wherein the head comprises a fixed planar portion coupled to the shank and at least one wing portion coupled to the fixed planar portion via a hinge, and
wherein the head further comprises an installation indicator positioned over at least a portion of both the fixed planar portion and the at least one wing portion; and
a base structure having a grommet portion that defines a grommet opening and a pair of legs resiliently coupled to the grommet portion and configured to engage with the opening,
wherein the grommet opening is configured to receive at least a portion of the shank and includes a protrusion feature configured to secure the lock pin relative to the base structure in a first assembled position.

16. The fastener assembly of claim 15, wherein a leg of the pair of legs includes a flex tab feature resiliently coupled thereto and configured to retain the base structure relative to the first component via the opening.

17. The fastener assembly of claim 16, wherein the pair of legs are spaced apart to define a central recess therebetween and the flex tab feature is configured to retract into the central recess during assembly.

18. The fastener assembly of claim 17, wherein the flex tab feature comprises a sloped body portion and a movable base portion that resiliently couples the flex tab feature to the leg.

19. The fastener assembly of claim 18, wherein the movable base portion is coupled to the leg at a surface thereof located within the central recess.

20. The fastener assembly of claim 15, wherein the installation indicator is a fiducial marker configured to be tracked by a visual quality system.
